(19) United States
(12) Patent Application Publication
(10) Pub. No.: US 2020/0406934 A1
(43) Pub. Date: Dec. 31, 2020

(54) REDUCTION OF DISTRACTIONS WITHIN THE SCOPE OF A TRANSFER OF DRIVING TASKS OF AN AUTOMATED VEHICLE TO A DRIVER

(71) Applicant: Robert Bosch GmbH, Stuttgart (DE)

(72) Inventor: Georg Krause, Heilbronn (DE)

(21) Appl. No.: 16/902,976

(22) Filed: Jun. 16, 2020

(30) Foreign Application Priority Data
Jun. 27, 2019 (DE) 102019209312.4

(51) Int. Cl. B60W 60/00; B60W 50/14; B60W 10/30

(52) U.S. Cl. CPC B60W 60/0055; B60W 60/0016; B60W 10/30; B60W 60/0054; B60W 50/14; B60W 60/0059

(57) ABSTRACT

A method for operating an automated vehicle. A request for the take-over of at least one driving task presently carried out by the automated vehicle is output to a driver of the automated vehicle. Prior to a transfer of the driving task to the driver following the request, at least one measure is carried out, with which at least one function of the automated vehicle, which represents a potential source of distraction for the driver during the transfer of the driving task, is deactivated or reduced.

### CROSS REFERENCE

The present application claims the benefit under 35 U.S.C. § 119 of German Patent Application No. DE 102019209312.4 filed on Jun. 27, 2019, which is expressly incorporated herein by reference in its entirety.

### FIELD

The present invention relates to a method for reducing distractions during a transfer of the vehicle guidance to a driver of an automated vehicle. The present invention furthermore relates to an accordingly designed control device for carrying out the method.

### BACKGROUND INFORMATION

Automated vehicles are able to carry out at least a portion of the driver's tasks automatically, i.e., without a human driver. A variety of methods for a longitudinal and transverse guidance of passenger cars driving in an automated manner are used for this purpose. The focus of these methods in general lies on lane center guidance, in which the vehicle is kept in the center of the traffic lane, as well as longitudinal control, in which a certain distance is maintained from preceding vehicles or other infrastructural circumstances. With the objective of implementing autonomous vehicles in the future, the development is presently focused on systems which offer at least partially automated driving. For example, vehicles of the autonomy level 3 (SAE Level 3) are highly automated vehicles, in which the driver does not have to constantly monitor the system, but the vehicle independently carries out functions such as the triggering of the turn signal, lane changes and lane keeping. The driver may turn to other things, but has to take over the vehicle guidance when needed as soon as he or she receives a corresponding request (take-over request, TOR) from the system within a defined advance warning time. The fully automated driving according to autonomy level 4 (SAE Level 4) represents a further development of the highly automated driving (SAE Level 3), and thus a precursor to autonomous driving (SAE Level 5). The vehicle is able to independently navigate the predominant portion of its driving in the process, it also being possible here for the driver to be requested to take over the vehicle guidance if the system can no longer cope with certain driving tasks. A request to have the driver take over the vehicle guidance take place, for example, in unusual traffic situations. These include, among other things, unusual traffic situations in which the system, for example, does not correctly identify unusual obstacles or in which roadway markings are absent. A TOR may furthermore take place when the system establishes that a map is not up-to-date or not present. Moreover, functional interferences and shortcomings of the system may cause a corresponding TOR. These occur particularly frequently in systems having little availability, in which the intervention of the driver forms a safety-relevant fallback position.

To ensure sufficient safety during the take-over of driving tasks, the driver has to sufficiently assess the situation within a certain transition time and take over the control of the vehicle. Since long transition times make the implementation of SAE Level 3 systems more difficult, it is desirable to preferably design the transfer process of the vehicle guidance in such a way that the driver is able to assume the vehicle control more quickly and, at the same time, make better-quality driving decisions. Existing systems typically use an audiovisual alarm or a vibration alarm as a notice or alarm for the impending transfer of the driving tasks.

### SUMMARY

It is an object of the present invention to provide an option for improving the situation assessment and take-over of the vehicle control within a relatively short transition time. This object may achieved in accordance with example embodiments of the present invention. Advantageous specific embodiments of the present invention are described herein.

In accordance with an example embodiment of the present invention, a method for operating an automated vehicle is provided, a request for the take-over of at least one driving task presently carried out by the automated vehicle being output to a driver of the automated vehicle. Prior to a transfer of the driving task to the driver following the request, at least one measure is carried out, with which at least one function of the automated vehicle, which represents a potential source of distraction for the driver during the transfer of the driving task, is deactivated or reduced. With the take-over request, the system automatically eliminates possible impairing or distracting elements from the perception of the driver, so that the driver may concentrate better on the driving situations and make higher-quality decisions. In this way, the likelihood of accidents due to an erroneous decision of the driver is reduced, and the driving safety of the automated vehicle is thus enhanced. This measure may furthermore shorten the transition time between the automated driving and the manual driving. As a result, the use and the development of the automated driving are simplified.

In one specific embodiment of the present invention, it is provided that a signal for reducing the brightness of a passenger compartment and/or instrument illumination of the automated vehicle is output as the measure. As a result of the reduced brightness of the passenger compartment illumination or of the instrument illumination, elements which are not required and are potentially distracting are suppressed from the perception of the driver so that other elements necessary for detecting the situation and taking over control are perceived more intensely. The reduction of the brightness of the passenger compartment and/or instrument illumination furthermore causes a better adaptation of the eye of the driver to the ambient illumination. This is advantageous, in particular, when driving at night or in tunnels since an eye adapted to the illumination in the passenger compartment of the vehicle has poorer perception of the dark outside surroundings. With the reduction of the passenger compartment and/or instrument illumination, it may furthermore also be signaled to the driver that a transfer of a driving task by the system is directly impending.

In one further specific embodiment of the present invention, it is provided that a signal for interrupting an audio and/or video playback on a playback device connected to the automated vehicle, or on an external device connected to the automated vehicle, is output as the measure. In this way, auditory and visual distraction sources are effectively eliminated, without the driver having to personally become active. The driver may furthermore better perceive auditory and/or visual signals which the system outputs as a notice or alarm for the impending transfer of a driving task or as status information to the driver. Moreover, the interruption of the audio and/or video playback may already signal to the driver that a transfer of a driving task by the system is directly impending.

In one further specific embodiment of the present invention, it is provided that a signal for interrupting a telephone and/or video call on a telecommunication device connected to the automated vehicle is output as the measure, without the driver having to personally become active. With this measure, it is ensured that the driver is not impaired by the existing telephone and/or video call during the transfer of the driving task. The driver may furthermore better perceive auditory and/or visual signals which the system outputs as a notice or alarm for the impending transfer of a driving task or as status information to the driver. Moreover, the automatic interruption of a telephone and/or video call may serve as a notice to the driver that a transfer of a driving task by the system is directly impending.

In one further specific embodiment of the present invention, it is provided that a signal for outputting a request for the take-over of the particular driving task by the driver on a secondary display unit of the automated vehicle is output as the measure. Since the secondary display unit, in general, has a larger design than the primary display unit above the steering wheel, all pieces of information may be seen thereon at a glance.

According to one further aspect of the present invention, a method for operating a multimedia control unit is provided, a signal for interrupting an audio and/or video playback being received from a control device of an automated vehicle connected to the multimedia control unit. As a result, the instantaneous audio and/or video playback is muted, interrupted or ended. With this measure, it is ensured that the driver is not impaired by a corresponding multimedia playback during the transfer of the driving task. The driver may furthermore better perceive auditory and/or visual signals which the system outputs as a notice for the impending transfer of a driving task or as status information to the driver. Moreover, the automatic interruption of the multimedia playback may serve as a notice to the driver that a transfer of a driving task by the system is directly impending.

According to one further aspect of the present invention, a method for operating a telecommunication device is provided, a signal for interrupting an instantaneous telephone and/or video call being received from a control device of an automated vehicle connected to the telecommunication device. As a result, the instantaneous telephone and/or video call is muted, paused or ended, without the driver having to personally become active. With this measure, it is ensured that the driver is not impaired by the existing telephone and/or video call during the transfer of the driving task. The driver may furthermore better perceive auditory and/or visual signals which the system outputs as a notice or alarm for the impending transfer of a driving task or as status information to the driver. Moreover, the automatic interruption of a telephone and/or video call may serve as a notice to the driver that a transfer of a driving task by the system is directly impending.

In one specific embodiment of the present invention, it is provided that a notice is output to a dialogue partner of the instantaneous telephone and/or video call that the instantaneous telephone and/or video call was automatically interrupted, without the driver having to personally become active. In this way, it is effectively prevented that the particular dialogue partner attempts to contact the driver of the automated vehicle again, by which the driver could possibly be impaired during the take-over of the driving task.

According to one further aspect of the present invention, a control device for controlling an automated vehicle is provided, which is configured to carry out at least some of the steps of the above-described method for operating an automated vehicle.

According to one further aspect of the present invention, a control device for controlling a multimedia control unit is provided, which is configured to carry out at least some of the steps of the above-described method for operating the multimedia control unit.

According to one further aspect of the present invention, a control device for controlling a telecommunication device is provided, which is configured to carry out at least some of the steps of the above-described method for operating a telecommunication device.

According to one further aspect of the present invention, a computer program encompassing commands is provided, which, during the execution of the computer program by a computer, prompt the computer to carry out one of the above-described methods.

Finally, according to one further aspect of the present invention, a computer-readable memory medium is provided, on which the above-described computer program is stored. The implementation of the concept in the form of a computer program offers greater flexibility.

The present invention is described in greater detail hereafter based on figures.

### BRIEF DESCRIPTION OF THE DRAWINGS

FIG. 1 schematically shows the passenger compartment of an automated vehicle.

FIG. 2 schematically shows an automated vehicle including a control device and components connected thereto.

FIG. 3 shows a block diagram to clarify the method running on the system.

### DETAILED DESCRIPTION OF EXAMPLE EMBODIMENTS

In accordance with an example embodiment of the present invention, a method is provided for controlling an automated vehicle, in which certain functions that are not necessary for the driver of the automated vehicle when taking over driving tasks, and thus represent potential impairment or distraction factors in this connection, are automatically eliminated or reduced. Depending on the application, impairment or distraction factors may be understood to mean different functions and elements of the automated vehicle and other devices situated in the automated vehicle which may have a visual, auditory, optical or other effect on the driver and which are not necessary for the impending take-over of the driving tasks.

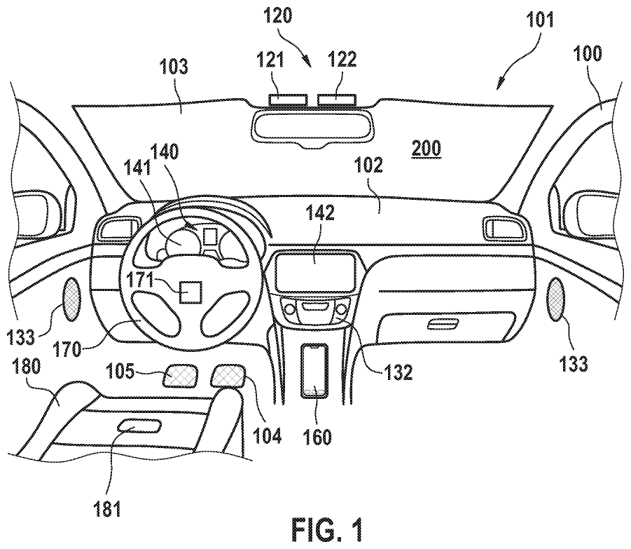

By way of example, FIG. 1 shows a passenger compartment of a typical passenger car 100 in this regard, which is implemented in the form of an automated vehicle. According to its autonomy level (SAE Level 3 or SAE Level 4), automated vehicle 100 independently carries out certain driving tasks. The intervention of the driver is only necessary in certain situations when the system is not able to cope with the driving tasks. For this purpose, automated vehicle 100 is also furthermore equipped with control elements, such as a steering wheel 140, a gas and a brake pedal 104, 105. Automated vehicle 100 furthermore encompasses an instrument panel 140 including a primary display unit 141 on which relevant pieces of technical information are displayed. The vehicle is furthermore equipped with a secondary display unit 132 which is generally situated in the center portion of dashboard 102 and with the aid of which expanded pieces of information may be represented. Secondary display unit 132, in general, also forms an image output unit of a multimedia system, to which also a multimedia playback device 132, such as a radio, and speakers 133 installed in passenger compartment 101 belong. The multimedia system may furthermore be connected to a communication device 150 of automated vehicle 100, via which a mobile terminal 160 for carrying out telephone calls and data links may be connected, for example wirelessly. A passenger compartment illumination 120 is furthermore accommodated in passenger compartment 101 of automated vehicle 100, which in general includes multiple separately switchable light sources 121, 122. Automated vehicle 100 may furthermore include a driver's seat 180 including an at least one actuator 181 for outputting vibration signals. Steering wheel 170 may also be equipped with a corresponding actuator 171 for outputting vibration signals. As is furthermore shown in FIG. 1, automated vehicle 100 typically also includes a front window 103 through which the driver, for performing driving tasks, is able to detect the instantaneous traffic situation by observing surroundings 200.

Automated driving functions typically run on dedicated control units or control devices, which emit signals for controlling actuators and other components. In the case of an impending transfer of driving functions of automated vehicle 100 to the driver, system 104 outputs a corresponding request 112 for the take-over of the driving functions to the driver. Presently, a control device 110 of automated vehicle 100 outputs suitable signals for this purpose to a primary display unit 141 above steering wheel 170, to speakers 133 or to vibration actuators 181 in driver's seat 180 to generate corresponding alarms for the driver.

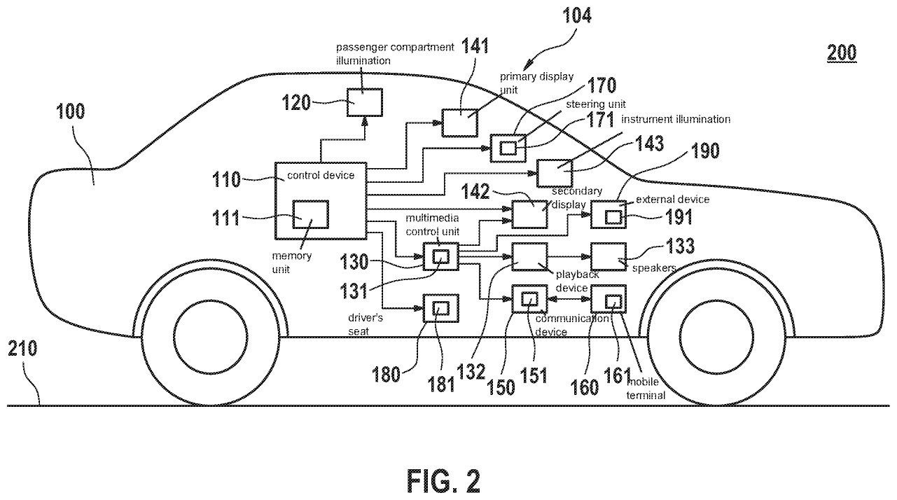

FIG. 2 shows a schematic representation of an automated vehicle 100 including a system 104 for carrying out the method. System 104 includes a control device 110, in the present example includes a memory unit 111, on which a computer program for carrying out the method is stored. Control device 110, which may be designed both in the form of a single control unit and in the form of multiple control units communicating with one another, outputs a request for the take-over of the driving tasks to the driver in the case of an impending transfer of driving tasks to the driver of automated vehicle 100. In the exemplary embodiment shown here, control device 110 is connected for this purpose, with the aid of suitable control lines or bus systems, to the following components of automated vehicle 100: a steering wheel 170 including an installed vibration actuator 171 for generating a vibration signal, a primary display unit 141 situated in the area of steering wheel 170 for generating visual notice or alarm signals, a driver's seat 180 including an installed vibration actuator 181 for generating a further vibration signal, and a multimedia control unit 130 including a speaker 133 connected thereto for generating an acoustic notice or alarm signal.

Control device 110 furthermore activates certain components of automated vehicle 100 using suitable signals in such a way that possible sources of impairment or distraction are preferably reduced or eliminated within the scope of a transfer of driving tasks to the driver. For this purpose, control device 110 is connected with the aid of suitable control lines or bus systems to the following components: passenger compartment illumination 120 for reducing the illumination in the vehicle passenger compartment, a playback device 132 or secondary display unit 142 for interrupting an audio and/or video playback taking place with its aid, and a vehicle-internal communication device 150 for interrupting a telephone and/or video call on a telecommunication device 160 connected thereto. Control device 110 is furthermore connected with the aid of multimedia control unit 130 or directly to secondary display unit 142 to display additional pieces of information about the impending transfer of the driving tasks to the driver. Control device 110 is furthermore connected with the aid of multimedia control unit 130 or directly to an external device 190 including a control device 191, which may be, for example, a notebook, headphones, video goggles, music playback device, etc., connected by wire or wirelessly to system 104.

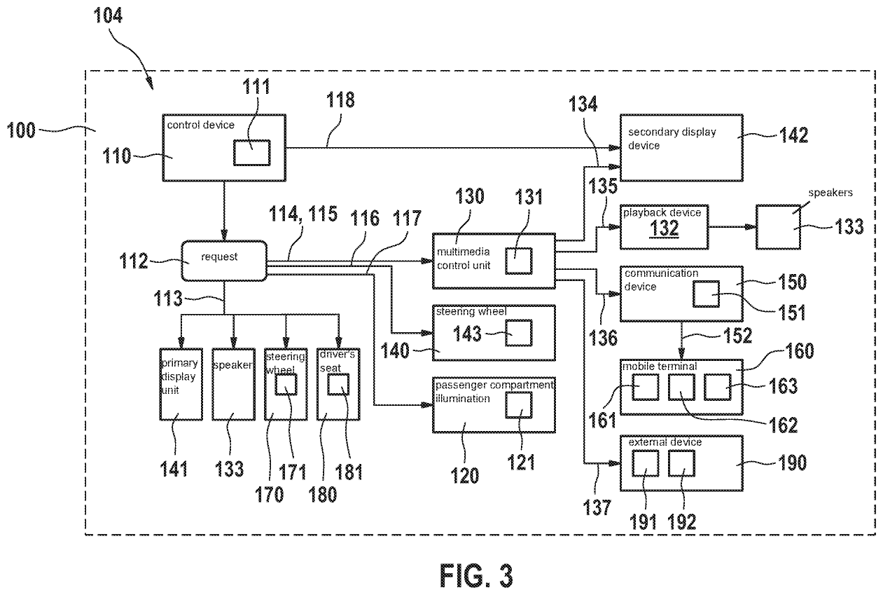

FIG. 3 shows a schematic diagram based on which the design of system 104 from FIG. 2 and the interaction between the components of system 104 are clarified. As was already described, control device 110, in the case of an impending transfer of the vehicle guidance, generates a request 112 for the take-over of the driving tasks which is directed to the driver. As a result of this request 112 or in parallel to the output of the respective take-over request 112, control device 110 generates corresponding signals 113, which prompt primary display unit 141 to represent visual notices, speakers 133 to output acoustic notices, and corresponding vibration actuators 171, 181 in steering wheel 170 or in driver's seat 180 to output haptic notices in the form of vibrations. Moreover, a further signal 114 is transmitted to multimedia control unit 130, which prompts multimedia control unit 130 to interrupt an instantaneously occurring playback of a multimedia content, such as for example a video playback on secondary display unit 142 or an audio playback on multimedia playback unit 132 taking place via speakers 133. Depending on the design, the multimedia playback may be muted, paused or ended. In principle, however, it is also possible to only reduce the volume of an audio playback or the brightness of a video playback. Upon receipt of its corresponding signal 114, multimedia control unit 130, with the aid of a corresponding signal 137, may also switch off or suspend devices 190 and components (for example notebook, headphones, video goggles etc.) connected thereto, which may represent potential sources of impairment or distraction during the impending take-over of the driving tasks by the driver. They may also be devices 190 which are connected wirelessly (e.g., with the aid of WiFi or Bluetooth) to multimedia control unit 130 or other components of automated vehicle 100. With the aid of a wireless communication link, corresponding devices 190 may also be directly connected to the speakers or to an Internet communication device of automated vehicle 100. Such configurations are possible since automated vehicle 100, in general, has larger antennas, such as a notebook or a mobile terminal. The respective devices 190 may include accordingly adapted software, which supports the suspension or shut-off by a corresponding signal of multimedia control unit 130. FIG. 3 shows such an external device 190 including an internal control device 191 for controlling device 190 and a memory unit 192, on which a computer program for controlling device 190 is stored, by way of example.

Control device 110 may furthermore generate a further signal 115, with the aid of which an instantaneous telephone or video call on a connected telecommunication device 160 is interrupted. Depending on the design, the particular call may be muted, paused or ended. However, it is also possible to only reduce the volume of the particular call. Telecommunication device 160, which in the present exemplary embodiment is a mobile terminal or cell phone connected to a vehicle-internal communication device 150 (e.g., a hands-free unit) by wire or wirelessly, has a control device 161 for controlling telecommunication device 160 and a memory unit 162, on which a computer program for controlling telecommunication device 160 is stored. Telecommunication device 160 furthermore typically also includes an internal communication device 163 for establishing a telecommunication link to an external infrastructure.

Since communication device 150, in turn, is connected to multimedia control unit 130, multimedia control unit 130, upon receiving signal 115 from control device 110, transmits a corresponding signal 136 to communication device 150. An internal control device 151 of communication device 150 consequently transmits a corresponding signal 152 to telecommunication device 160, which prompts telecommunication device 160 to interrupt the instantaneous telephone or video call. Telecommunication device 160 may also be a device fixedly installed in the vehicle. Telecommunication device 160 may furthermore also be connected directly to multimedia control unit 130 or to control device 110. Telecommunication device 160 is preferably designed, upon receipt of a corresponding signal 152, to transmit a notification to the dialogue partner, which informs the particular dialogue partner that the instantaneous telephone or video call is being automatically interrupted. The reason for this measure may also be communicated to the dialogue partner in the process. In this way, it is avoided that the particular dialogue partner attempts to contact the driver of automated vehicle 100 again during the take-over of the driving tasks. Such a notification may be, for example, a voice message recorded in advance or generated by speech synthesis.

To prepare the driver of automated vehicle 100 for the impending take-over of driving tasks, certain pieces of information may be output on secondary display unit 142. These include, in particular, pieces of information about the status of automated vehicle 100, information about the instantaneous traffic situation or pieces of information as to why a corresponding request for taking over the driving task has taken place or which problem the system has identified. As is indicated in FIG. 3, control device 110 transmits a corresponding signal 118 to secondary display unit 142 for this purpose, which prompts secondary display unit 142 to represent the corresponding pieces of information. The corresponding pieces of information may be transmitted to secondary display unit 142 together with signal 142. In principle, the transmission of corresponding pieces of information may also take place by other components of automated vehicle 100, for example by multimedia control unit 130. In this case, control device 110 transmits corresponding pieces of information to multimedia control unit 130.

Although the present invention was illustrated and described in detail by the preferred exemplary embodiments, the present invention is not limited by the described examples. Rather, other variations may be derived therefrom by those skilled in the art without departing from the scope of protection of the present invention.

What is claimed is:

1. A method for operating an automated vehicle, comprising the following steps:
outputting a request for a take-over of at least one driving task presently carried out by the automated vehicle to a driver of the automated vehicle; and
prior to a transfer of the driving task to the driver subsequent to the request, carrying out at least one measure with which at least one function of the automated vehicle, which represents a potential source of distraction for the driver during the transfer of the driving task, is deactivated or reduced.

2. The method as recited in claim 1, wherein a signal for reducing a brightness of a passenger compartment illumination of the automated vehicle and/or a signal a for reducing the brightness of an instrument illumination of the automated vehicle, is output as the measure.

3. The method as recited in claim 1, wherein a signal for interrupting an audio playback and/or video playback on a playback device connected to the automated vehicle or on an external device connected to the automated vehicle, is output as the measure.

4. The method as recited in claim 1, wherein a signal for interrupting a telephone and/or video call on a telecommunication device connected to the automated vehicle is output as the measure.

5. The method as recited in claim 1, wherein a signal for outputting a request for the take-over of a driving task by the driver on a secondary display unit of the automated vehicle is output as the measure.

6. A method for operating a multimedia control unit for an automated vehicle, the method comprising the following steps:
receiving a signal for interrupting an instantaneous audio and/or video playback being received from a control device of an automated vehicle connected to the multimedia control unit; and
in response to the signal, muting, interrupting or ending the instantaneous audio and/or video playback.

7. A method for operating a telecommunication device, the method comprising the following steps:
receiving a signal for interrupting an instantaneous telephone and/or video call being received from a control device of an automated vehicle connected to the telecommunication unit; and
in response to the signal, interrupting the instantaneous telephone or video call by muting, pausing, or ending the instantaneous telephone and/or video call.

8. The method as recited in claim 7, wherein notice is output to a dialogue partner of the instantaneous telephone and/or video call that the instantaneous telephone and/or video call was automatically interrupted.

9. A control device for controlling an automated vehicle, the control device configured to:
output a request for a take-over of at least one driving task presently carried out by the automated vehicle to a driver of the automated vehicle; and
prior to a transfer of the driving task to the driver subsequent to the request, carry out at least one measure with which at least one function of the automated vehicle, which represents a potential source of distraction for the driver during the transfer of the driving task, is deactivated or reduced.

10. A control device for controlling a multimedia control unit, the control device configured to:
receive a signal for interrupting an instantaneous audio and/or video playback being received from a control device of an automated vehicle connected to the multimedia control unit; and
in response to the signal, mute, interrupt, or end the instantaneous audio and/or video playback.

11. A control device for controlling a telecommunication unit, the control device configured to:
receive a signal for interrupting an instantaneous telephone and/or video call being received from a control device of an automated vehicle connected to the telecommunication unit; and
in response to the signal, interrupt the instantaneous telephone or video call by muting, pausing, or ending the instantaneous telephone and/or video call.

12. A non-transitory computer-readable memory medium on which is stored a computer program for operating an automated vehicle, the computer program, when executed by a computer, causing the computer to perform the following steps:
outputting a request for a take-over of at least one driving task presently carried out by the automated vehicle to a driver of the automated vehicle; and
prior to a transfer of the driving task to the driver subsequent to the request, carrying out at least one measure with which at least one function of the automated vehicle, which represents a potential source of distraction for the driver during the transfer of the driving task, is deactivated or reduced.
